(19) United States
(12) Patent Application Publication
(10) Pub. No.: US 2010/0169119 A1
(43) Pub. Date: Jul. 1, 2010

(54) Systems and Methods for Delivering Continuous Quality Improvement to Complex Non-Manufacturing Industry

(76) Inventor: Anwar A. Hussain, Vestal, NY (US)

Correspondence Address: Anwar A. Hussain, Apt. 22, 435 Plaza Drive, Vestal, NY, 13850, US

(21) Appl. No.: 12/347,235

(22) Filed: Dec. 31, 2008

(51) Int. Cl. G06Q 50/00; G06Q 10/00; G06F 17/30; G06F 17/40; G06N 5/02

(52) U.S. Cl. 705/3; 705/11; 705/7; 706/47; 707/E17.032; 707/E17.044

(57) ABSTRACT

A system and method is disclosed to functionally show how to use a technology-based continuous quality improvement platform with software integration to improve the execution of complex processes in a measurable way. The platform demonstrates how healthcare delivery, as one example of a complex process, is represented as an input-output system (inputs represent determinants of outcomes, and outputs represent the impact those determinants have on specific measures). The software system helps execute tasks, monitors responses (i.e. outputs), learns (by correlating inputs to outputs), and adjusts (by providing practical decision support to users); ultimately these are the basic steps to create a technology based continuous quality improvement methodology for complex systems.

Healthcare as one example of a complex input-output model: Inputs represent the ingredients and contextual factors of healthcare delivery that would have impact on metrics that are tracked (i.e. outputs), one category of which include the execution of specific patient tasks. By monitoring outcomes (i.e. what has happened to the patient after the execution of said tasks), the system can statistically connect which specific inputs (or specifically which tasks) tightly correlate with outcomes. This correlation can then be utilized to generate task-based decision-support, recommending certain specific tasks be done and in which order because these tasks are tightly correlated with improved outcomes. This input-output methodology can be extended to all of healthcare delivery and also to other industries that can be structured within an input-output model.

### FIELD OF THE INVENTION

The present invention relates generally to information technology systems, and in particular, to medical information systems for correlating multi-dimensional clinical, efficiency and financial inputs and outputs, and method thereof for delivering continuous quality improvements in healthcare.

### BACKGROUND OF THE INVENTION

In the United States, more is spent on healthcare than in any other industrialized nation, yet nearly 47 million citizens remain uninsured. These weaknesses persist despite continued efforts to address them. One fundamental problem that curtails our ability to make improvements is that no known methods have been able to differentiate “good” medical care from “poor” medical care. In other words, there is very poor ability to predict how patients will do with specific interventions or a collection of interventions. No coherent and comprehensive mechanism exists to bring about cost-effectiveness to our healthcare system because of this fundamental lack of transparency. Although the United States may be one of the most advanced in technical medicine (i.e. drugs, procedures, research), the infrastructure to measure effectiveness of such advances remains rudimentary at best. The health system as it currently exists includes inpatient and outpatient hospital services, services provided by physicians and laboratories, and various other nursing services, just to list a few aspects of healthcare delivery.

Some of the factors contributing to the growth in healthcare in recent years have been the emergence and integration of new medical technologies and services. While some innovations may be inexpensive, most are costly and are adding quickly to the total costs of care. It is rare that technological innovation results in reduced expenditures in clinical practice. In fact, technological developments have led to expanded treatment and higher costs; and future growth likely will accelerate that trend.

Without a better understanding of how clinical care is directly associated with patient outcomes; and how administrative decisions, insurance stipulations, and treatment options interact to predict outcomes, the ability to create a cost-effective system will remain difficult to achieve. This inability to differentiate good quality care also prevents us from creating valid cost-constraints on a system that seems to grow interminably. Without solutions to curtail rising healthcare costs, millions of individuals, insurance companies, and medical providers, will be impacted, not to mention implications for U.S. government entitlement programs such as Medicare and Medicaid.

Currently, healthcare is considered to be one of the most inefficient industries. Some data suggests that about one-third of expenses (approximately $800 billion) per year are due to inefficiency. In fact, healthcare is the largest part of the U.S. economy; 15% of gross domestic product (GDP) and costing $2 trillion in annual spending in 2005. By 2015, healthcare is expected to account for 20% of the GDP and cost $4 trillion annually. Efforts to curb this growth and bring about efficiency have had little effect.

In the past, two broad categories of methods have been employed to try to facilitate efficiency in healthcare delivery: 1) industrial quality improvement techniques and 2) information technology implementation. For example, hospitals and other healthcare providers have borrowed tools and concepts in quality improvement from manufacturing industries (e.g. Toyota Production System) with hopes of bringing efficiency. Manufacturing and other industries, however, have simpler linear processes and lack complex multivariate conditions as prevalent in healthcare. Ultimately, such industrial techniques have failed to be adopted due to such limitations.

Healthcare, as a complex adaptive system (CAS), has many qualities that make it difficult to integrate linear quality improvement techniques (as is done in simpler systems such as manufacturing). “Reductionist” approaches to improving efficiency oversimplify the healthcare process and hence have not been broadly utilized by healthcare. Physicians and other providers work with probabilities, not absolutes, in choosing treatments. They evaluate trade-offs (e.g., avoiding dangerous drug interactions, even though several drugs may individually help the patient), and digest an ever-increasing knowledge base of research. Patients arrive with unique combinations of health and disease, respond differently to interventions (drugs or procedures), and can choose whether to accept care.

Issues unrelated to the patient-doctor relationship further complicate matters. Patients may have poor access to services. Many cannot afford care, and seek it only when disease has significantly progressed. Medicine is not a linear process, and is better described by a non-linear, multivariate model. Few interventions, if any, incorporate such complexities of a multivariate healthcare system.

The other broad area of intervention used to try to bring efficiency to healthcare delivery is the use of information technology (IT). The electronic medical record (EMR), as one common and well-known example of IT, is a repository of patient health information and was originally designed for billing and compliance purposes. It does not manage the “work” aspects of care, and in fact, many users complain that it slows down their work. Other industries have proven that optimization of work is the fundamental way of improving outcomes. The use of IT in healthcare has failed to optimize work and has very little to no connection to improved patient outcomes. Other IT systems (e.g. computerized physician order entry), in fact, have unfortunately been associated with having a negative impact on outcomes (e.g. a notable increase in patient medical errors). Again, this is likely due to the fundamental way that EMRs and other current IT platforms are designed.

Regrettably, healthcare lacks a comprehensive infrastructure to manage execution of work, measure such work in detail, and provide feedback mechanisms to improve that work. Although methodologies and infrastructure have been used in other industries, the complexities of healthcare have prevented any easy fix. There is no solution to date that can reproducibly and measurably improve efficiency or outcomes. Thus, the problems of healthcare seem to grow infinitely in terms of costs. The current healthcare system is cost-driven rather than cost-efficiency driven. The lack of cost-effective mechanisms forces decisions to be made purely on costs rather than the true effectiveness of an intervention. For example, if two interventions for a specific disease cost $100 and $1000 respectively, in our current approach we would likely choose the $100 intervention simply because it is cheaper. In fact, if we had the data the $1000 intervention may have been “cheaper” in the long run because it would prevent the patient from having recurring problems in the future. Such recurrences would likely cost more than the $900 that we currently thought we saved. If a mechanism to assess cost-effectiveness existed, then the choice to pick the $1000 intervention would have been easy. Current health information technology has not integrated any cost-effective mechanisms as thus described.

A logical approach to the problem is to build information technology systems that capture multivariable inputs (i.e. capture work and other factors that likely impact patients) and better predict outputs (i.e. patient outcomes). Unfortunately, existing information systems have only rudimentary capability in capturing multivariate data, and hence have shown little ability to reduce costs, and have had no impact on outcomes. Again, the electronic medical record was primarily designed for billing and storing patient data. It was not designed to manage real-time care, as when doctors see and treat patients in person, nor was the system developed to collect the rich data needed to build better predictive models. For example, healthcare tasks are a proxy for workflow, a very good representation of specific interventions that are provided to the patient. Existing information technology tools, however, do not help manage tasks well. The tools may allow the doctor to initiate the task, but never manage the task in detail nor do such systems capture specific patient responses to interventions.

Other system-wide problems that preclude healthcare from being cost-effective include major weaknesses in feedback methods. Feedback mechanisms in healthcare tend to use aggregated general data (rather than specifics that show actionable feedback at the individual patient level), are delayed (often several months old), and are not provided at the point of care (at the point where the patient is being treated). Current information technology tools do not have appropriate feedback mechanisms to provide detailed analysis to use in refining healthcare delivery. For example, treatment for women and men has often been standardized—despite research evidence clearly showing differing patient care needs based on sex. Systems need much better ability to capture detailed data, analyze it, and provide individualized interventions.

Thus, there is a need for a system and process to facilitate the execution of work, measurement of work, and a feedback mechanism to optimize work. The system would be capable of capturing the multivariate complexities of healthcare delivery, analyzing such data, and providing detailed and actionable feedback—all with the goal of bringing a mechanism to enable more cost-effective healthcare delivery. In other words, the desired technology system will implement a reproducible mechanism such that continuous quality improvements in provider services can be provided at the point of care. As this system collects more data, it should continue to further optimize delivery.

Desirably, the system of the present invention will be capable of correlating multivariate inputs (e.g. all factors that may have an impact on patients) with outputs (e.g. improvements in patient outcome measures); and provide a specified method thereof for delivering continuous quality care or services in any non-manufacturing industry or business. That methodology can also be applied to optimizing other categories of outcomes (e.g. efficiency or financial metrics) in healthcare and other similar industries.

Such a system will help to create better predictive models of metrics of healthcare delivery and ultimately measurably improve and expedite patient care. Such a system will utilize a wide array of hardware and software tools such as mobile devices, radio-frequency identification (RFID) technology, and existing computer systems to capture more than 90% of relevant inputs. Furthermore, this technology-based continuous quality improvement system will provide a cost-effective model to bring efficiency to any other non-manufacturing industry which fits a similar input-output structure as exists in healthcare delivery.

### SUMMARY OF THE INVENTION

According to an illustrative embodiment of the present invention, a technology-based continuous quality improvement system is disclosed having a plurality of user interfaces for access and retrieval of data corresponding to respective subjects, a server connecting multiple databases, and business logic software methods integrated between the plurality of user interfaces and the server such that the system provides improved treatments, including real-time continuous improvement.

In summary, the continuous quality improvement (CQI) system of the present invention is a technology platform that collects process and clinical data and other categories of data to create a novel database that can be used in the analysis of quality and other metrics of interest. The database can be combined and/or compared to administrative databases (e.g. HEDIS) in measuring quality. Furthermore, through data mining, the CQI system is used to create healthcare measures of quality that utilize more than simple binary, point-in-time measures as are used currently. Instead this novel approach would create measures to incorporate multi-dimensional and complex data for appropriately measuring the quality of healthcare. Also, the database analyses can be used to create better predictive models because it correlates inputs (i.e. categories of data that likely have an impact on metrics) with outputs (i.e. improvements in quality or other metrics). The CQI system may also be used in a “discovery” process in another embodiment. Analysis of delivery processes allows one to look for associations that may yet be unknown. For example, time-to-intervention (e.g. how quickly a drug is provided to a patient if he has a certain illness requiring that drug) may have significant impact on outcomes in some disease states than in others. Certain “what if” questions may also be asked: for example, would reduction in amount of workload on providers reduce the risk of patient-related medication errors?

A mechanism of decision support is also created within the CQI system. By analyzing the database, physicians and other providers have real-time, point-of-care, and actionable feedback on patient care. For example, the system would provide specific suggestions about which drugs, tests, or other tasks helped in managing previous patients. Such actionable feedback allows the user to modify behavior, making it possible for the feedback to optimize delivery (i.e. providing the right care at the right time). The CQI information technology platform is scalable to the entire hospital and outpatient market; and has measurable quality effects through the collection and analysis of more high-resolution process and clinical data as more patient data becomes part of the database.

Furthermore, current and stable enterprise computing technologies have been included in the CQI system to ensure the system produces a highly stable and fast system. The computing framework comprises a high-speed system (delivering transaction time of about 0.3 seconds or less); stability and consistency in a 24/7, round the clock operational time; and scalability from the individual department to the entire health system or even to defense, industry and security operations. The system provides for relatively easy implementation and for scalability.

Embodiments of the CQI software system provide a combination of interfaces that include mobile devices, PCs, tablet PCs, or any other hardware that provides a graphical user interface for this system's users. The requirements for development include a device's capability in offering APIs, providing a rich user experience, along with stability, scalability, and security. Examples of a mobile device that may be used include HTC or iPhone, or any other compatible system.

In addition, a communication strategy adopted via Wi-Fi and or WAP may be utilized in the system of the present invention, or any other system that may be implanted to enhance speed of data transfer. Online and offline management of data and user accessibility shall also be addressed. The CQI system can support creation of applications that efficiently use the resources on the mobile devices, or may be expanded to increase features and functionality. Further, the CQI system integrates with third party systems including PACS, Laboratory Information Systems, EMR, RFID and any other needed system that would allow the CQI system to execute its goal in improving quality.

Thus, in one embodiment, the hardware of the system will include multiple user interfaces that allow users to interact with the system, a server/database that stores and analyzes data, and a communication platform that shuttles data from and to different parts of the system. The software associated with the system includes an integration layer (connected to other databases to glean needed information) and a logic layer that drives the collection, analysis and management of data.

Specifically, aspects of the system include hardware and software components, the hardware comprising components as used currently in the industry. The software, however, comprises a logic layer and an integration layer. The novel mechanism of the logic layer may be incorporated into other industries that have a similar complex interaction of inputs and outputs.

In one embodiment, the mechanism provides improved treatments, the method comprising the steps of providing an information system that has the capacity for storing a plurality of input parameters and a plurality of outputs, the plurality of outputs including metrics characterized by defined improvements in outcomes and one or more feedback mechanism to specific users; collecting the plurality of input parameters from multiple sources; correlating the plurality of input parameters with the plurality of outputs; integrating the plurality of input parameters with the plurality of outputs into one or more databases; analyzing the plurality of input parameters and the plurality of outputs; selecting one or more data values after analyzing the data; detecting a pattern of tasks or pattern of inputs which correspond to the defined improvements in outcomes; and creating decision-support feedback to aid a user in delivering improved treatments, processes, or mechanisms to a subject. The information technology system integrates business logic software methodology within a computer-based method for optimizing one or more data values. The quality improvement mechanism may assess financial, clinical, and/or efficiency measures, or any other categorical measures as selected by the user.

In another embodiment, the method for managing successful transactions in any complex non-manufacturing industry comprises the steps of receiving a plurality of input parameters and a plurality of outputs, the plurality of outputs including optimization metrics, wherein the optimization metrics comprise financial, clinical, and efficiency measures; retrieving the plurality of input parameters and plurality of outputs from a server connecting multiple databases; integrating the input parameters with the plurality of outputs into one or more databases; and providing real-time decision-support through business logic software which correlates the plurality of input parameters and the plurality of outputs, statistically analyzes prior courses of action which have a positive or negative impact, and creates up-to-date options within a feedback system to improve the metrics of interest. The software may be designed for industries to manage multiple inputs and outputs while providing decision-support to optimize outputs. The software may be incorporated into administration systems, analytical economic systems, healthcare systems, defense systems, or any other non-manufacturing systems that are structured using an input-output model.

An exemplary embodiment of the computerized task management system integrates business logic software for optimizing healthcare delivery such that it comprises a plurality of user interfaces for access and retrieval of data corresponding to one or more patients and other classes of inputs, the data including a plurality of inputs and a plurality of outputs; one or more servers connecting multiple databases; and a software system comprising a business logic layer which executes a specific algorithm as it correlates the plurality of inputs and the plurality of outputs to optimize specific outputs.

Still, other aspects, embodiments, and advantages are discussed in detail below. Moreover, it is to be understood that both the foregoing general description and the following detailed description are merely illustrative examples, and are intended to provide an overview or framework for understanding the nature and character of the embodiments claimed and described. The accompanying drawings are included to provide a further understanding of the various embodiments claimed and described, are incorporated in and constitute a part of this specification, and, together with the description, serve to explain the principles and operations of the various embodiments claimed and described.

### BRIEF DESCRIPTION OF THE DRAWINGS

The invention is best understood from the following detailed description when read with the accompanying drawing figures. It is emphasized that the various features are not necessarily drawn to scale. In fact, the dimensions may be arbitrarily increased or decreased for clarity of discussion.

FIG. 1 is a diagram depicting the flow of information through the quality management system in embodiments of the invention. It describes the basic flow of information as demonstrated in the continuous quality platform. It depicts a closed-loop system of how a system executes work, measures the work, learns from such work and provides feedback to continually improve this process.

FIG. 2A is a diagram illustrating another configuration of a continuous quality improvement system according to embodiments of the present invention. To create a continuous quality improvement cycle, a correlation must be drawn about how inputs affect outputs, then learning from that connection and providing functional feedback (i.e. actionable feedback).

FIG. 2B is a diagram illustrating the configuration of a continuous quality improvement system including exemplary systems for integral phases of the cycle according to embodiments of the present invention. It provides an example of how the system's logic layer executes tasks, measures patient responses, correlates inputs to outputs and provides decision-support to the user based on such analyses. For example, a set of orders for a patient with a heart attack (myocardial infarction) are executed; the responses to the interventions are measured in the patient (length-of-stay [LOS] in the hospital, changes in vital signs [VS], and changes in symptoms; the analysis carried out to correlate which interventions improve patient measures (i.e. which inputs improve outputs); and then finally task-based feedback is provided to the person or user who started the orders.

FIG. 3 is a flow diagram representing data flow through the systems of FIGS. 1 and 2. It is specifically designed to improve patient outcomes (i.e. reduce mortality, and reduce morbidity in patients) using a continuous quality model depicted above. In addition, the figure depicts the specific categories of information it will automatically search for (through multiple means such as capturing detail information on specific interventions done to patients and integrating into other databases) in order to strengthen the input-output equation as depicted above.

FIG. 4 is a simplified block diagram depicting the architecture of the technology platform of the invention. It depicts a simplified block diagram of one of many possible embodiments of the system architecture including the logic layer.

FIG. 5 is a schematic illustration which conforms to various aspects of embodiments of the invention. This represents a more detailed view of one of many possible embodiments of the system architecture, as designed based on cost, scalability, speed, security, and other metrics that would be used to create a robust system.

FIG. 6 is a schematic illustration of the technology platform in another embodiment of the invention. The schematic illustrates aspects of the architecture that can potentially be utilized.

FIG. 7 is a more detailed schematic illustration of the technology platform including third-party systems in embodiments of the invention.

### DETAILED DESCRIPTION

In the following detailed description, for purposes of explanation and not limitation, exemplary embodiments disclosing specific details are set forth in order to provide a thorough understanding of the present invention. However, it will be apparent to one having ordinary skill in the art that the present invention may be practiced in other embodiments that depart from the specific details disclosed herein. In other instances, detailed descriptions of well-known devices and methods may be omitted so as not to obscure the description of the present invention.

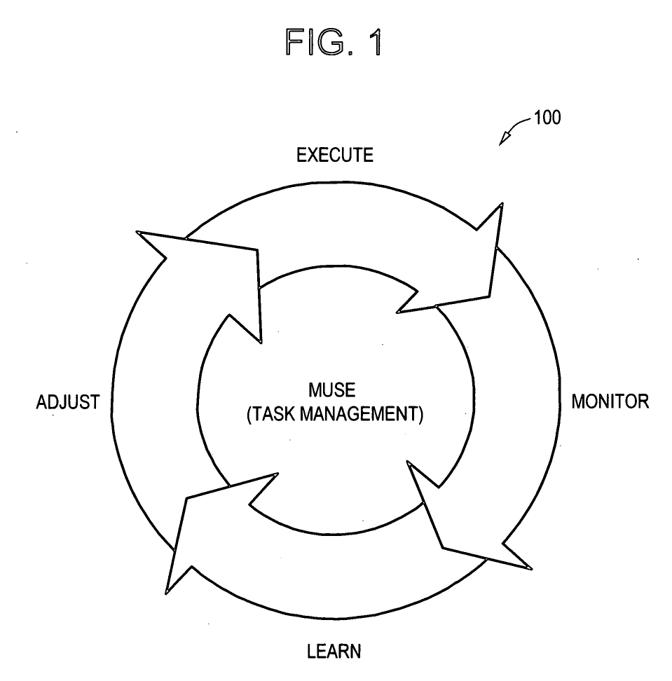

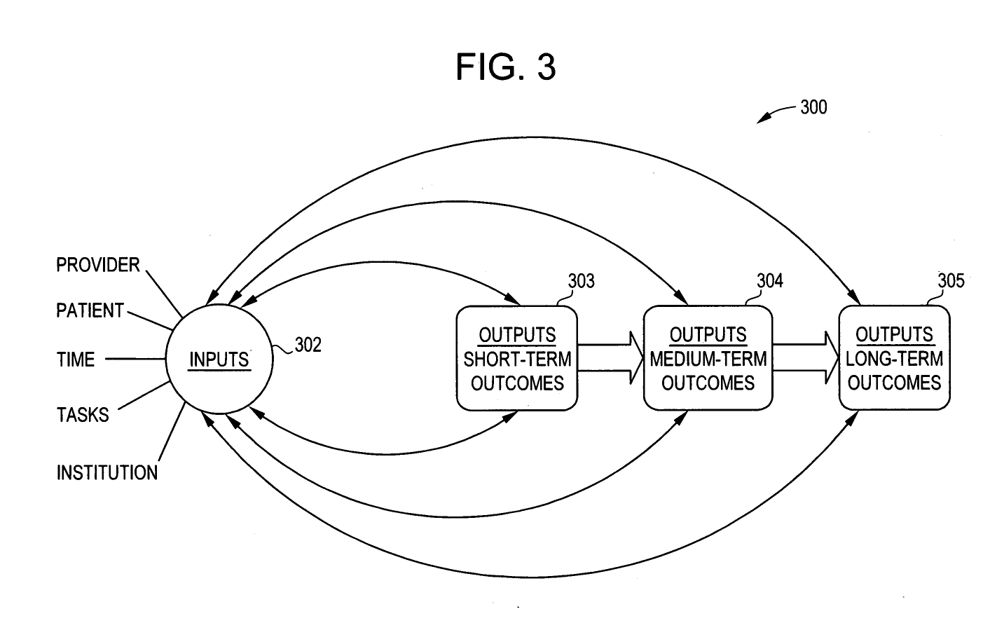

A system and method is disclosed, as follows, to functionally show how to use a technology-based task-management platform 100 with software integration, to improve the delivery of healthcare in a measurable way. The platform 100, as conceptually depicted in a schematic diagram of FIG. 1 demonstrates how healthcare delivery is represented as an input-output system (inputs represent determinants of outcomes, and outputs represent the impact those determinants have on specific measures). Specifically the system makes this input-output system practical by executing, monitoring, learning, and adjusting inputs and correlating them with outputs/outcomes. Inputs represent the ingredients and contextual factors of healthcare delivery, one category of which include the execution of specific patient tasks (see FIG. 3 for detailed and more expansive example of inputs).

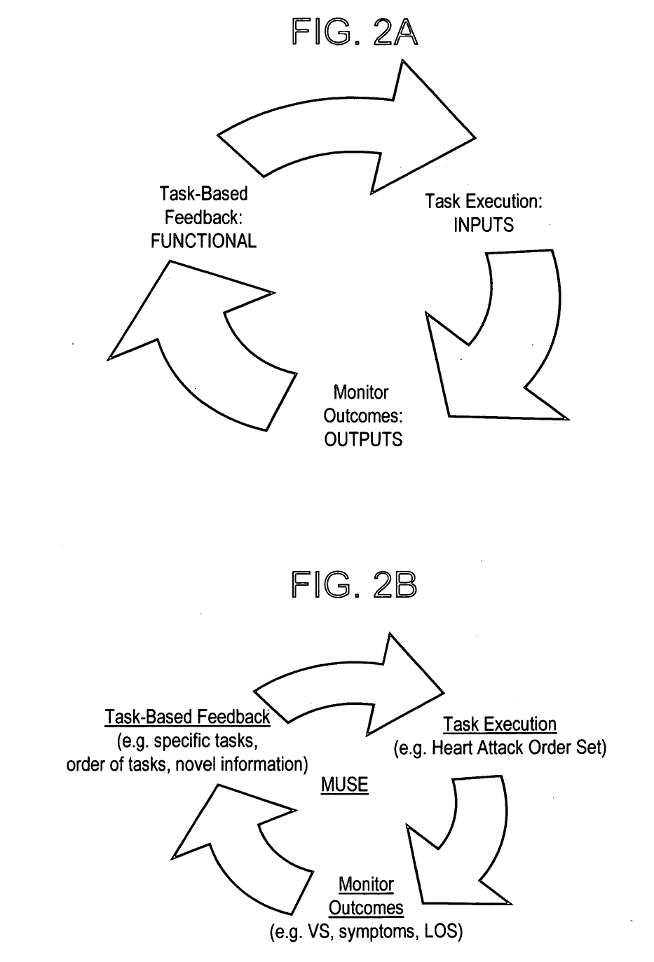

FIGS. 2A and 2B, for example, illustrate one type of input, the execution of a set of tasks done for the patient (e.g. the execution of a set of tasks in a “heart attack” as in FIG. 2B). By monitoring outcomes (i.e. what has happened to the patient after the execution of said tasks), such as changes in vital signs (VS), in symptoms, and in length of stay (LOS), the system can statistically connect which specific inputs (or specifically which tasks) tightly correlate with outcomes. This correlation can then be utilized to generate task-based feedback (for example, the system would recommend certain specific tasks be done and in which order because these tasks are tightly correlated with improved outcomes). Outputs represent the end-point that is the result of the inputs. For instance, after treating a patient with a certain pain medication, an expected output would be to see a reduction in pain in the patient. The system measures the strength of these connections in individual patients because not all patients respond the same to pain medications. Some may respond more quickly and have quick alleviation of pain and other patients would need some other type of pain medication because they did not have a measurable reduction in pain. In the latter scenario, the system provides task-based feedback (i.e. it would recommend that another medication be tried and would offer specific options and specific doses).

Statistically (e.g. using logistic or linear regression models; or other techniques), inputs can be tightly correlated with outputs as more data is collected. If we have data from hundreds of patients about a certain input (e.g. drug) causing a wanted output (e.g. pain reduction), then this data becomes useful data at the next visit by a patient who is in need of pain reduction. Feedback can be provided to the user (in task form) when the next patient is available; task-based feedback would involve the system displaying to the user which drug and dosing worked best for this specific type of patient based on past experience. In addition, subsequent visits by the patient to see this doctor or department would refine the database further. The system would offer this feedback and “close the loop”, ultimately creating a continuous quality improvement cycle using tasks as the basis for feedback. This closed-loop cycle is depicted in FIGS. 2A and 2B.

A schematic diagram of FIG. 2B illustrates an embodiment of a more complex input-output system, and how to use the task-management platform to implement a continuous quality improvement process (CQI). Specifically, it shows how a system can correlate between inputs (i.e. what was done to a patient with a heart attack) and outputs (i.e. what happens to vital signs, to symptoms, and to length-of-stay (LOS) at first. Subsequently, the system would provide feedback. In other words, it would provide feedback about which specific tasks, which order of tasks, and any other novel information about how such tasks affected outputs. The user can then utilize the new feedback for future execution of tasks. Ultimately, such an input-output loop can be used in any non-manufacturing industry that can correlate inputs with outputs and provide functional feedback (i.e. actionable feedback) that can then be used to further optimize the loop.

In this diagram, a patient with a heart attack comes into an emergency room and has a certain set of tasks (i.e. order set) executed. In the next step the system would monitor outcomes (i.e. changes in appropriate metrics such as vital signs [e.g. changes in blood pressure], length-of-stay of the patient in the ER, and changes in patient symptoms [e.g. reduction in chest pain in this patient with a heart attack]). The next step involves the use of statistical methods (e.g. linear regression or other techniques) to correlate inputs to outputs (changes in outcomes).

The system is able to execute such work because it can capture high resolution detail about which tasks were ordered, delays in execution of each task if any, and prioritization of tasks—just to name a few details about what is captured. As data on tens to hundreds of heart attack patients is collected, the system correlates more definitively which tasks, done in which order, and how quickly such tasks are needed to be done to get the best outputs/outcomes, as would be defined. The correlation of data with functional task-based feedback can then provide continuous quality improvements such that the information can then be provided to the user in real-time at the time the next heart attack patient visits the emergency department. Certainly, this process can be done in other departments in the hospital, in clinics and any other venue that provides care to patients. The system may change its recommendations in the long run based on contextual issues (e.g. a new patient may be older and data has shown that tasks need to be done differently in such patient because he responds differently to specific interventions as compared to younger patients).

The systems and methods of the present invention build on a new conceptual model that connects inputs to outputs. A schematic diagram of an embodiment of the input-output CQI system 300 is depicted in FIG. 3. As demonstrated, patient care and outcomes is defined as an input-output based system. The inputs (i.e. factors that would impact patient outcomes) include several categories of factors that affect outputs (i.e. patient outcomes). The outputs/outcomes are measured as improvements in certain metrics (e.g. reduction in mortality). The data collected to improve patient outcomes is based on about five or more [exemplary] specified parameters that are likely to be tightly linked to outcomes 303/304/305, the input parameters 302 including the following: (a) patient characteristics: how the patient presents in terms of his/her individual health status including age, history of disease, particular behaviors (e.g. smoking or drinking alcohol, etc.), drugs being used, genetic data, environmental exposure, allergies to medication, diseases and severity of each; (b) provider characteristics: type of provider (e.g. M.D., D.O., R.N., L.P.N., and anyone with direct patient care), specialty of the provider, years of experience, any specialty training, fellowships, etc.; (c) institutional characteristics: type of facility (e.g. hospital, clinic), size of the facility in terms of number of beds, capabilities (i.e. is it a level one trauma center?), nurse to patient ratio etc.; (d) time: duration of time since the onset of symptoms, delays that have occurred in treatment (e.g. delays in drug administration in a hospital), order of drugs administered, time it took to administer drug to patient, continuous tracking of patient care movement within the facility (e.g. how long did patient spend in waiting room), specific times of treatment and evaluations (e.g. many disease states, such as sinusitis, improve with no intervention or minimal intervention, and therefore time would be a defined input); (e) tasks: specific interventions that are done to the patient (e.g. blood tests, specific drugs prescribed and used, imaging, surgeries, consultations with specialists, counseling to change behavior or improve compliance with drugs and/or other therapies or treatments (e.g. stop smoking).

In one aspect, outputs are defined in terms of short-term outcomes 303, medium-term outcomes 304, and long-term outcomes 305, not limited to the exemplary terms. The short-term outcomes 303 are measures that are near future outputs that can be measured or determined within a short duration (e.g. minutes to hours to see valid changes), or do not take much time to change (e.g. changes in blood pressure). Medium-term outcomes 304 are measures that are measured over the course of days, weeks, months (e.g. hospital length of stay for a patient who was admitted for a heart attack). Long-term outcomes 305 are measures that are measured over years (e.g. mortality rate of a patient with diabetes). In building the platform 300, the database pulls as much information about inputs as is possible and collects information on the outputs simultaneously, or as the outcomes are determined. Using statistical and other means (i.e. mathematical models, data analysis, linear regression), the system will correlate which inputs matter most, those that have been pre-determined, pre-defined, or are qualifying factors, in each category of outcomes, short-term 303, medium-term 304, or long-term 305. This information is then used to provide feedback at the point of care (i.e. at the patient bedside). An example of feedback, or decision-support, is to tell the physician that a certain set of tasks need to be done in a certain order and within a certain amount of time to improve medium-term outcomes. Information flow is depicted by arrows in the illustration of FIG. 3. The system is further guided by user-weighting of outputs. For example, length-of-stay may be the output to optimize in the emergency department but length-of-stay may not be a priority in some specialty clinics (e.g. a cancer clinic that sees very few patients in a day).

Having set up the conceptual model, the CQI system will pull data from any area in order to build an individualized and patient-specific “patient model” using above parameters (e.g. what interventions work and do not work for this specific patient, how best to implement interventions for this specific patient, tracking of this patient's health over time). As it collects more data, the system can provide better feedback, and decision support, to the user as it builds a clearer picture of the types of patients and the inputs that will be specifically effective.

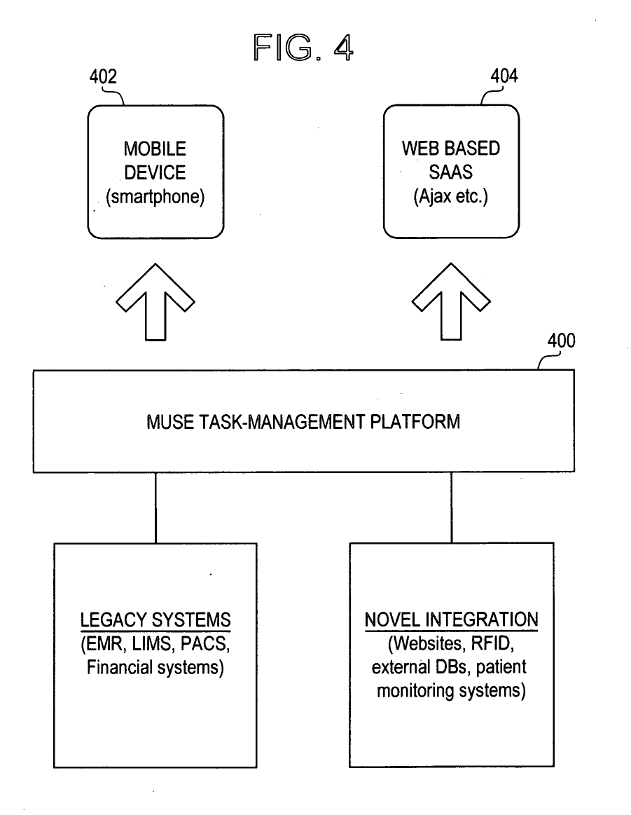

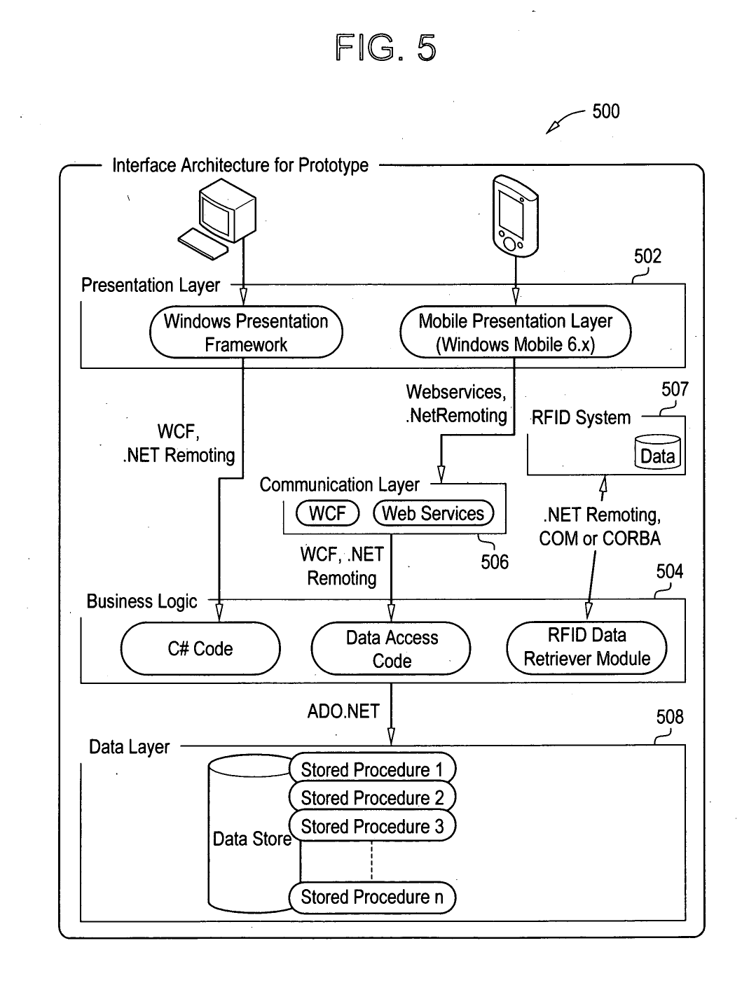

The block diagram of FIG. 4 illustrates basic schematic of an embodiment of a conceptual CQI management system 400 of the present invention. The user interacts with a handheld or mobile device 402 which serves as the interface for entry of tasks, or “inputs.” The handheld device 402 can be used to order interventions such as drugs, lab tests, and other medical treatment. The PC/tablet 404 and/or other desktop machines 404 act as backup or central systems, particularly in the event of signal loss or if the mobile device is not working properly, as represented by the web-based SAAS (as is also illustrated in FIG. 5). The emphasis here in FIG. 4 would be on using easily implementable software (e.g. browser technology). The CQI “task management platform” 400 represents the system software that manages all tasks (i.e. tracking tasks, updating the system as tasks are completed, pushing tasks to the right person; including an appropriate communication platform to complement task management. The integration of the system (i.e. linking into other systems) incorporates multiple databases where the system software can pull pre-defined/designated data about inputs. Integration into other systems is driven by the system to proactively seek data that is described in FIG. 3. For example, patient demographic data is included in existing hospital systems (i.e. legacy systems). The system would actively seek such information about patient characteristics in order to tightly correlate inputs to outputs. In other words, integration as defined in FIG. 4 is driven by the system's needs to capture as many INPUTS as possible in the input-output system.

Furthermore, integration may be into disparate databases—integration into legacy systems that exist within a hospital (or clinic) where the system is to be deployed and also integration into new databases that likely exist outside of the hospital or are new systems that are added to the task management platform 400 in order to enhance the input-output equation. For example, a certain website may provide information on drugs that can help the doctor execute drug tasks much more easily. In that case, the task management platform would integrate into such a system. If a database has no utilization in implementing the input-output equation, the task management platform may be designed without integration with such a system.

For exemplary purposes, and not limitation, if the continuous quality improvement system utilizes its software to optimize financial outcomes, then the system can integrate into existing hospital financial databases. Under this scenario, financial outcomes (e.g. optimizing profit for patient stay) would be tracked as are patient outcomes as described above. In one aspect, the goal of the software system would be to include financial optimization of patient care, capturing data concerning private and public health insurance programs, costs of treatments etc. Such analysis can lead to determining capital efficiency measures for the provider system, optimizing use of instrumentation and equipment available, available beds etc. For example, the system can optimize the scheduling of x-rays on a certain set of machines in order to minimize downtime of the machines, and increase revenue by correct scheduling.

In another aspect of the present invention, integration into other databases can help the user execute tasks. Another example includes a database from a large clinical trial which can provide data about specific drugs and their side effects. If a set of patients come into the emergency department, and all are on the same drug, the system may flag a particular side effect because that effect is common to all of those patients. In summary, integration will be done with any system(s) that will help the CQI loop as described above by enabling continuous improvements—whether the need is to optimize clinical, financial or efficiency outcomes (or any other category of outcomes).

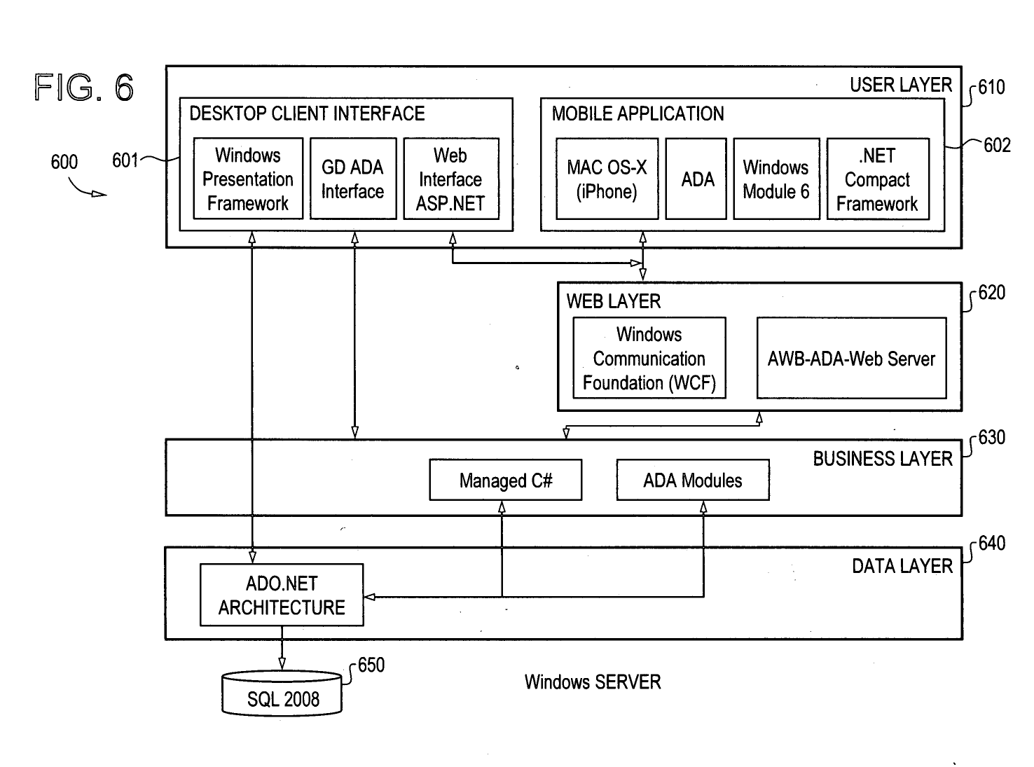

FIGS. 5 and 6 both provide details as to the descriptions of components of the task management system. One embodiment in FIG. 5 presents the CQI system as an architectural representation. The task management platform 500 includes a presentation layer 502 which has a Windows presentation framework as one example of presentation layers. In one aspect, the interface between these presentation layers and a business logic layer 504 incorporates a communication layer 506. The business logic layer 504 enables the above detailed CQI framework and analysis; the data for use by the logic layer resides within the stored data layer 508. Each framework distinctly provides the ability for the interactive CQI management system 500 and to provide decision-support in terms of speed, reliability, scalability, and as discussed prior.

In one aspect, the Windows presentation foundation (WPF) 502 is a next-generation presentation system for building Windows client applications (i.e. the graphical user interface). With WPF, a wide range of both stand-alone and browser-hosted application can be created. A web communications foundation (WCF) is a set of .NET technologies for building and running connected systems, communications infrastructure built around the Web services architecture. In combination, a complete web development framework is provided with an embedded web server. In another aspect, the web server can be embedded into an application so that the application can talk with a standard web browser like Microsoft Internet Explorer or Netscape Communicator, for example.

In yet another aspect of FIG. 5, for exemplary purposes and not limitation, Windows Mobile 6 is utilized as the mobile application since it is a platform for mobile devices; and is used in a wide variety of third party hardware, such as handheld computers, personal digital assistants (PDAs), and smartphones. Microsoft Visual Studio 2005 and Windows Mobile 6 make it possible to create software for the Windows Mobile platform in both native (Visual C++) and managed (Visual C#, ADA, VB.NET code). In one aspect, the Microsoft®.NET Compact Framework is a smart device development framework that brings managed code and XML web services to devices. The Compact framework is a rich subset of the .NET framework, thus providing the same benefits as the .NET framework; but it is designed specifically for resource-constrained devices, such as handhelds, PDAs, and smart mobile phones. The Compact framework greatly simplifies the process of creating and deploying applications to mobile devices while also allowing the developer to take full advantage of the capabilities of the device.

Similarly, in another aspect of FIG. 5, the business logic layer has access to a radio-frequency identification (RFID) system 507 for integral incorporation of data into the module 504. The RFID system is implemented to capture details about temporal aspects (i.e. time) of patient care (i.e. one of the major inputs into the input-output model as described above). This type of integration resides on a computer, and links two software applications because of its well-documented software library. Other interfaces or integration, however, may be implemented in this step and therefore the API system is for exemplary purposes and not limitation. The business logic layer 504 thus incorporates C# code, data access code, and/or a RFID data retriever module.

In other aspects of the CQI system, the ADO.NET architecture provides two ways to access and manipulated data via the: (1).NET framework data providers whereby the components have been explicitly designed for data manipulation and fast, forward-only, read-only access to data, and (2) DataSet designed for data access independent of any data source, which may be used with multiple and differing data sources, used with SML data, or used to manage data local to the application. The data layer 508 stores the data from multiple stored procedural protocols.

Another embodiment of the CQI system is represented by the schematic illustration of the task management platform 600 in FIG. 6. The system 600 utilizes multiple frameworks including a user layer 610, a web layer 620, a business layer 630, a data layer 640 and a server 650. In one embodiment, the user layer 610 integrates a desktop client interface 601 and/or a mobile application 602. In one aspect, the desktop client interface 101 is a Windows presentation foundation (WPF) as discussed supra. The desktop client interface 601 may also include a GtkADA interface, ASP.NET interface, or other; the mobile application 602, as illustrated for exemplary purposes, includes an iPhone MAC OS-X, ADA, Windows Mobile 6, and/or .NET Compact Framework applications. For exemplary purposes and not limitation, the Microsoft ASP.NET allows programmers to create dynamic web applications. ASP.NET 3.5 has the AJAX capability integrated. In another aspect, Windows Mobile 6 is exemplified as the mobile application.

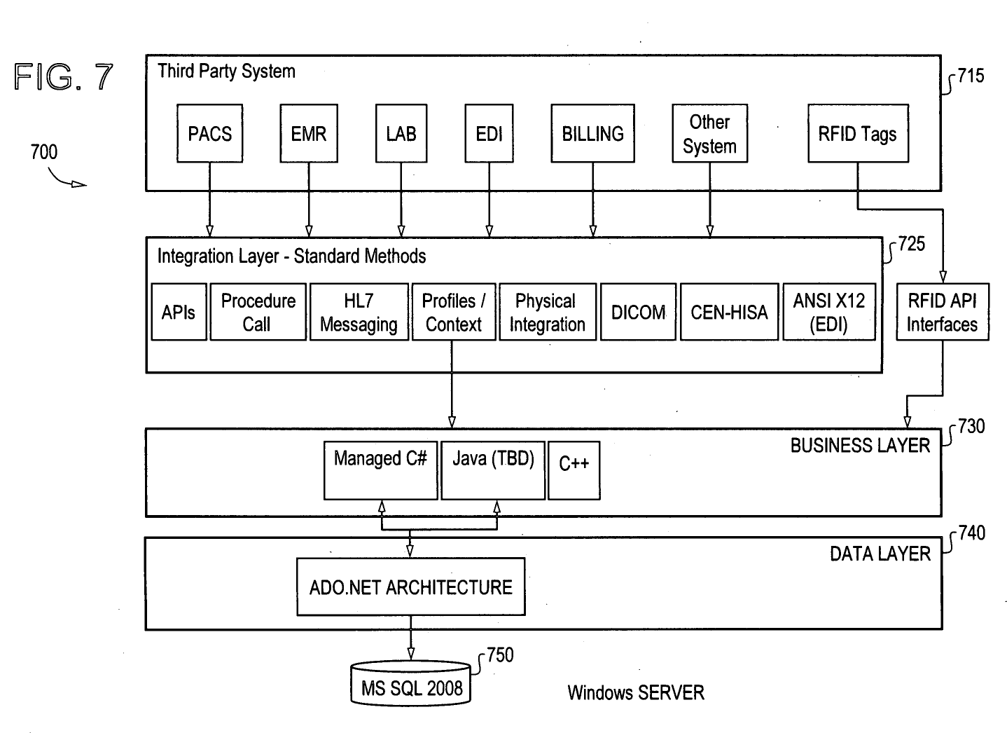

One embodiment of the task management system of FIG. 7 depicts the technology platform with different aspects of integration, creating a framework 700 that includes: any number of third party systems 715, an integration layer 725, a business layer 730, a data layer 740 and a server 750. In one embodiment, the third party systems 715 include a Picture Archiving and Communication System (PACS), electronic medical records (EMRs), laboratory records/results (LAB), electronic data interchange. (EDI), other insurance data, billing, and any other databases that would have data needed in the continuous quality improvement methodology as described above. Further, other third party systems may be integrated from outside the realm of healthcare and where efficiency measures are desired to provide a real-time analysis and decision support system based on input-output correlations. For example, financial or insurance databases may be integrated to collect data in optimizing financial metrics.

Also in FIG. 7 are representations of integration layers 725 which depicts some methods used in integration including: (1) API level integration in which web services are utilized to access the APIs; (2) Procedure-Call in which a remote procedure call or a standard command such as SQL queries can be used to retrieve data; (3) Messaging using well-known standards such as DICOM for imaging and HL7 Messaging; (4) Integration Profiles, specific subsets of the standard to enable seamless integration; (5) Context Integration, an intermediary passing any context changes through applications; and (6) Physical Integration, integrating the physical hardware and typically sharing the operating system that runs the applications.

To further elaborate on the messaging applications, HL7 messages are used for interchange between hospital and physician record systems, and between EMR systems and practice management systems. The HL7 Clinical Document Architecture (CDA) documents are used to communicate documents such as physician notes and other material. Another service standard includes CEN-HISA (EN 12967), (HISA, Health Informatics Service Architecture) for inter-system communication in a clinical information environment. A set of transaction protocols (and U.S. national standards body for maintenance of electronic data interchange (EDI), ANSI X12 (EDI), is used for transmitting virtually any aspect of patient data.

Another aspect of FIG. 7 includes the business layer 730 comprising one or more software systems including managed C#, JAVA, and/or C++. The data layer 740, as demonstrated here, is an ADO.NET architecture which then feeds into the Windows server 750 (e.g. MS SQL 2008). Other software options may also be used (e.g. other open-source tools or other software languages). This embodiment in no way limits the system to use only these tools or approaches mentioned.

The application embodied discloses a method to functionally show how to use a technology platform to improve the delivery of healthcare in a measurable way. There are several components. The platform allows users to execute their work and captures details of such execution (these execution details along with data from integrating into other databases form the inputs into the input-output system). The system captures responses of patients to such interventions or work (patient responses such as mortality or morbidity data are the outputs in an input-output system). The system statistically (or through other methods) correlates said interventions (inputs) to specific patient responses (outputs). It then uses the correlations to provide feedback to the user about which interventions (in high levels of detail) improve outcomes.

A specific example:

A patient with chest pain comes to the emergency department and has certain interventions initiated and executed (these tasks represent one set of inputs into the system). The system then captures certain patient outcomes/outputs of interest (e.g. reduction of pain, improved vital signs, reduction in the amount of time the patient spends in the emergency department), and then analyzes the data in further detail. A goal of this analysis is to connect which interventions (i.e. inputs) improved the outcomes of interest (i.e, outputs). Finally, on a subsequent visit by another patient with chest pain the system would provide feedback at that time before initiation of interventions for this next patient. In this example, the doctor would be told via software that previous chest pain patients had the best outcomes (i.e. improvement in pain, reduction in length of stay, improved vital signs) if certain specific interventions were done, in a certain order and within a certain time frame. These interventions could mean drugs, procedures, or other such interventions. Specifically, designing such functionality allows for the feedback be actionable, be as close to real-time as possible, and be continuously updated based on statistical analysis by the system.

Functionally, the components of the present invention as previous described surpass other methods which have tried to facilitate healthcare delivery. The methods disclosed herein include a novel approach to building technology, and creating tools that better mimic workflow at the point of care (i.e. at the time when the doctor or other provider is seeing and taking care of the patient).

Workflow management in healthcare via the technology platform will facilitate the healthcare provided by physicians and other providers who are task-based (meaning that they break down their complex work into specific tasks). For example, a patient may need a chest x-ray. This represents a specific task that needs to be accomplished and the results need to be sent to the provider who ordered the test. The platform helps the doctor manage the task—after ordering the task, the doctor knows who is responsible to carry out the task; if there are delays, he can communicate with the person carrying out the order, and thus impact the results of the task. The system is an extension of this example, meaning it will eventually help manage the coordination and execution of hundreds to thousands of such tasks. These tasks and the details of their execution provide part of the data in the “input” side of the input-output model.

Tasks are a proxy for clinical workflow, a very good representation of specific interventions that are done to the patient. The system monitors aspects of patient response in a dynamic fashion. The system would, for example, track hourly changes in blood pressure in a patient whose blood pressure may change based on his getting a drug (a specific task), monitoring patient responses to specific interventions. The system would automatically request blood pressure checks every hour based on specific interventions (e.g. the drug sent as a task has an effect on blood pressure). By capturing the details of these patient responses, the system is able to collect information about the “output” side of the input-output model. As it analyzes the connections and correlations between inputs and outputs, the system provides a novel approach to decision support to users. As each patient is seen, the system uses previous data to connect tasks to patient responses (i.e. outcomes). At subsequent visits by the same type of patient, the system proactively provides specific data from analysis. In conclusion, embodiments of the disclosed invention and associated information technology tools have been integrated to help manage the task, and further provide detailed assessment of the task(s). Ultimately, a task management platform fits in seamlessly into the workflow of providers; hence, user adoption will be much quicker.

Furthermore, feedback mechanisms in healthcare that have tended to aggregate data (and make data less usable due to its non-specific nature) now will have the capability to incorporate the technology of the present invention that designate specifics to show actionable feedback at the patient level, have real-time accessibility and data analysis, and be provided at the point of care. Embodiments of the disclosed invention herein have built in mechanisms to enable the CQI system to be a comprehensive tool. Thus, a detailed level of analysis and feedback will enhance the delivery of healthcare, and further enable other non-manufacturing industries to improve their performance through input-output correlations. For example, if a patient comes in with chest pain and the system has analyzed many such patients, the CQI system (task management platform) can provide specific data: which tasks improved outcomes the best, the order in which the tasks need to be done, how quickly they need to be done; which tasks have not been helpful though done commonly. The system provides such support at the time when patients are being cared for.

Also, the system may also have potential to do “discovery”; because the system is able to connect inputs (i.e. interventions or tasks) with outputs (i.e. patient responses), it would be able to do automatic statistical analysis, looking for novel correlations. For example, it may be found out through such analysis that time-to-intervention would improve patient outcomes (i.e. giving a drug within a certain amount of time would reduce the amount of time the patient spends in the hospital). These associations would be flagged and provided to the user, who can do further analysis.

Also, the system can study existing and unexplained patterns in healthcare. For example, it is well-known that women often get different care than men do in hospitals. With the CQI system of the present invention, it could be determined why and under which circumstances care differs. Is it that women come in with symptoms that are different than men which leads doctors down a different path of analysis? Is it that interventions for women and men are different? Is it that there are delays in the execution of men's or women's interventions? These capabilities help clarify many patterns that exist in healthcare, and would help reduce unnecessary variability in healthcare delivery to different populations.

In addition, the system can run quality improvement trials in a scientific fashion. Both retrospective/observational research and prospective research can be performed and analyzed simultaneously and/or in real-time. A data model can be set up (patient, provider, institution, interventions, environment and time) and then parameters collected on such information from these patients. Having set up this model, the system can do, for example, Phase 4 monitory of drugs (i.e. drugs that are new to the market, but there may be effects that have not been documented). Furthermore, the hospital or users may decide to test if changing order of tasks done has an impact on outcomes; and these sorts of changes and their effects can be tracked in detail using this system.

Currently, reimbursement mechanisms in healthcare have lots of problems because payment does not correlate with the work done by the specific providers. In other words, the primary care physician may be doing more work in caring for a patient than a specialist but the specialist will be paid more due to the current payment framework. Because the system can track “work” in much greater detail than has previously been possible, it can be used as a more valid framework for payment of services. If, for example, Medicare is trying to pay for services of one of its members and the person has been to multiple providers, the total payment can be divided based on work (task-based) and the amount of time per task. This is for exemplary purposes, however, and not limitation, where any number of assigned or designated functions may be performed within the task management platform which would enable continuous quality improvements. The distributed system also helps create better predictive models and metrics of healthcare delivery. Because the system can create better predictive models, for example, it can create novel measures of quality that are more tightly correlated with patient outcomes. Current measures of quality are point-in-time, binary and do not take into account the complexity of care. The current measures also correlate poorly with patient outcomes. As described in embodiments of the present invention, measures are likely multi-dimensional, not static, and are likely graded rather than binary (i.e. yes or no); clearly, then, they would be more tightly correlated with patient and other outcomes

Any areas of the healthcare, within different specialties, and even throughout other non-manufacturing systems would be able to incorporate the information technology task management platform of the present invention. The real-time correlation of data in an input-output system may be utilized in any other industry (e.g. defense) that may benefit through the use of a high efficiency system of data correlation, user support, and decision support through real-time feedback.

In one embodiment, the usable, scalable system seamlessly supports the many tasks healthcare providers execute, while gathering data to be used with statistical, machine learning, and data mining approaches that enable many kinds of multidisciplinary research. These data will be used to develop better measures of quality that can revolutionize the healthcare delivery process. Artifacts of the proposed research include new algorithms, methodologies, and paradigms for human interaction with computing devices representing many different form factors.

Defining novel quality parameters using data collected through this system can be used to improve outcomes such as in reducing waste, in improving the patient experience, in improving patient safety, and improving clinical outcomes. Since these factors are for exemplary purposes and not limitation, other defined qualifying factors may be designated and incorporated as based on particular users and the field of medicine, technology, or industry. As demonstrated in the above disclosure, the novel mechanism of the present invention brings about concrete and continuous improvements in healthcare.

The previously unforeseen benefits have been realized and conveniently offer advantages for real-time healthcare delivery and efficiency in providing patient care, with improvements in clinical, financial, and for efficiency metrics. The system and process facilitate the execution of work, measurement of work, and enables a feedback mechanism to improve that work. The system accommodates the complexities of healthcare, including current administrative and bureaucratic rules while also taking into account reproducible and measurable outcomes to enable a more efficient and consistent measure of patient care, treatments, and improvements. The system further enables more user-friendly solutions for delivering real-time feedback at the point of care such that continuous quality healthcare and improvements in provider services can be provided at the point of care.

Further, the system of the present invention is capable of integrating multi-dimensional clinical input and output, and method thereof for delivering continuous quality care and/or services in any non-manufacturing industry or business. Since healthcare work is highly complex, the system is designed with a keen and multidimensional understanding of clinical work, the system of which provides a patient-provider interface, but may be manipulated to create a customized user interface in multiple settings outside of healthcare.

As exemplified, the system of the present invention may include any additional features, functionalities, and external party systems that may further improve the healthcare delivery system. Any real-time or otherwise correlation of input-output data and simultaneous feedback incorporating such features or functions with the capacity to integrate with the various components of the system may also be included within the software task management platform, or implemented in an external system and linked into the system of the present invention. The invention being thus described, it would be obvious that the same may be varied in many ways by one of ordinary skill in the art having had the benefit of the present disclosure. Such variations are not regarded as a departure from the spirit and scope of the invention, and such modifications as would be obvious to one skilled in the art are intended to be included within the scope of the following claims and their legal equivalents.

1. In a technology-based continuous quality improvement system having a plurality of user interfaces for access and retrieval of data corresponding to respective subjects, a server connecting multiple databases, and business logic methods integrated between the plurality of user interfaces and the server, a method for providing improved treatments, the method comprising the steps of:
providing an information system having a capacity for storing a plurality of input parameters and a plurality of outputs, the plurality of outputs including metrics characterized by defined improvements in outcomes and one or more feedback mechanisms to specific users
collecting the plurality of input parameters from multiple sources;
correlating the plurality of input parameters with the plurality of outputs;
integrating the plurality of input parameters with the plurality of outputs into one or more databases;
analyzing the plurality of input parameters and the plurality of outputs;
selecting one or more data values, following said step of analyzing, as indicative of the defined improvements in outcomes;
detecting a pattern of tasks or pattern of inputs which correspond to the defined improvements in outcomes; and
creating decision-support feedback to aid a user in delivering improved treatments, processes, or mechanisms to a subject.

2. The method of claim 1, wherein the step of providing an information system integrates business logic software methodology within a computer-based method for optimization of the one or more data values.

3. The method of claim 1, wherein the step of selecting one or more data values comprises a step of assessing financial, clinical, efficiency measures, and other classes of measures as selected.

4. The method of claim 1, wherein the step of collecting input parameters includes accumulating input parameters in at least one internal or external database.

5. The method of claim 4, wherein the step of accumulating input parameters from internal and external databases comprises a step of capturing a wide variety of input parameters with probable outcomes such that the input parameters to analyze patient outcomes comprise at least data on patient characteristics, provider characteristics, institutional characteristics, time, and patient-specific tasks and interventions.

6. The method of claim 5 wherein the classes of measures to be optimized are defined by the user.

7. The method of claim 6, wherein the user optimizes at least one financial measure and at least one patient measure.

8. The method of claim 1, wherein the user prioritizes metrics for optimization.

9. The method of claim 4, wherein the step of accumulating input parameters from internal and external databases comprises a step of correlating inputs with one or more financial, clinical, and efficiency measure.

10. The method of claim 1, wherein the step of collecting input parameters from multiple sources, the multiple sources comprise any category of database and data storage entity.

11. The method of claim 1, wherein the step of correlating the plurality of outputs with the plurality of input parameters relies on linear regression or other statistical techniques.

12. The method of claim 1, wherein the step of creating decision-support feedback is task-based, actionable, and designed to allow users to act on the decision-support feedback immediately.

13. The method of claim 1, wherein the step of creating decision-support feedback is customized to the user.

14. The method of claim 1, wherein the step of correlating the plurality of outputs comprises monitoring short-term outcomes, medium-term outcomes, and long-term outcomes to provide improved treatment at the point of patient care.

15. A method for managing successful transactions comprising the steps of:
receiving a plurality of input parameters and a plurality of outputs, the plurality of outputs including optimization metrics, wherein the optimization metrics comprise financial, clinical, and efficiency measures;
retrieving the plurality of input parameters and plurality of outputs from a server connecting multiple databases;
integrating the input parameters with the plurality of outputs into one or more databases; and
providing real-time decision-support through business logic software;
wherein the business logic software correlates the plurality of input parameters and the plurality of outputs, statistically analyzes prior courses of action which have a positive or negative impact, and creates up-to-date options within a feedback system to improve the metrics of interest.

16. The method of claim 15, wherein the software is designed for industries to manage multiple inputs and outputs while providing decision-support to optimize outputs.

17. The method of claim 15, wherein the software may be incorporated into administration systems, analytical economic systems, healthcare systems, defense systems, or any other non-manufacturing systems that are structured using an input-output model.

18. A computerized task management system integrating business logic software for optimization of healthcare delivery comprising:
a plurality of user interfaces for access and retrieval of data corresponding to one or more patients and other classes of inputs, the data including a plurality of inputs and a plurality of outputs;
one or more servers connecting multiple databases; and
a software system which integrates the plurality of user interfaces and the one or more servers, the software system comprising a business logic layer which executes a specific algorithm as it correlates the plurality of inputs and plurality of outputs to optimize specific outputs;
wherein the software system provides decision-support feedback impacting financial outcomes, clinical and efficiency measures, or other classes of measures.

19. The computerized task management system of claim 18, wherein the software system detects a pattern of inputs in relation to patient outputs and then uses decision-support feedback to implement a technology based continuous quality improvement methodology.

20. The computerized task management system of claim 18, further comprising the integration of one or more third party systems for optimization of short-term, medium-term, and long-term outcomes.
